(19) United States
(12) Patent Application Publication
(10) Pub. No.: US 2020/0308888 A1
(43) Pub. Date: Oct. 1, 2020

(54) ROTATABLE DAMPERS WITH FREE ENDS

(71) Applicant: Hewlett-Packard Development Company, L.P., Spring, TX (US)

(72) Inventors: Ryan M Smith, San Diego, CA (US); Rene Octavio Valenzuela-Rivas, San Diego, CA (US)

(21) Appl. No.: 16/769,349

(22) PCT Filed: Jan. 19, 2018
(86) PCT No.: PCT/US2018/014439

§ 371 Date: Jun. 3, 2020

(51) Int. Cl. E05F 3/10; F16F 13/00

(52) U.S. Cl. CPC E05F 3/10; F16F 13/007; E05Y 2900/606; E05Y 2201/264; E05Y 2900/602; E05Y 2201/21

(57) ABSTRACT

An example apparatus includes a first component including an abutment, a second component rotatable with respect to the first component, and a damper that includes a pivot end that is pivot connected to the second component and a free end that is free to abut the abutment of the first component. The damper is to dampen movement of the second component when the free end of the damper abuts the abutment of the first component.

### BACKGROUND

Dampers are used in a variety of machines to dampen motion of various parts. One type of damper contains an oil or other fluid that dampens motion through the dissipation of kinetic or thermal energy. A piston having a hole therein may be forced through the fluid to provide a dampening force. Other types of dampers are also known.

### BRIEF DESCRIPTION OF THE DRAWINGS

FIG. 1 is a schematic side view of an example apparatus including an example pivot connected damper having a free end.

FIG. 2 is a schematic side view of the example apparatus of FIG. 1 with the example damper in a contact position.

FIG. 3 is a schematic side view of the example apparatus of FIG. 1 with the example damper in a dampening position.

FIG. 4 is a schematic side view of an example electromechanical apparatus including an example pivot connected damper having a free end,

FIG. 5 is a schematic side view of the example electromechanical apparatus of FIG. 4 with the example damper in a contact position.

FIG. 6 is a schematic side view of the example electromechanical apparatus of FIG. 4 with the example damper in a dampening position.

FIG. 7 is an example graph of dampening force versus rotation for an example pivot connected damper having a free end.

### DETAILED DESCRIPTION

A linear damper may be pivot or rotationally connected to a component, such as a lid, and have its other end free. As the lid closes, the free end comes into contact with another component, such as a base, and provides a dampening effect as the lid continues to move towards the base. When opening the lid, the damper may not provide dampening, as its free end is free to lift away from the base, which may be aided by a return bias.

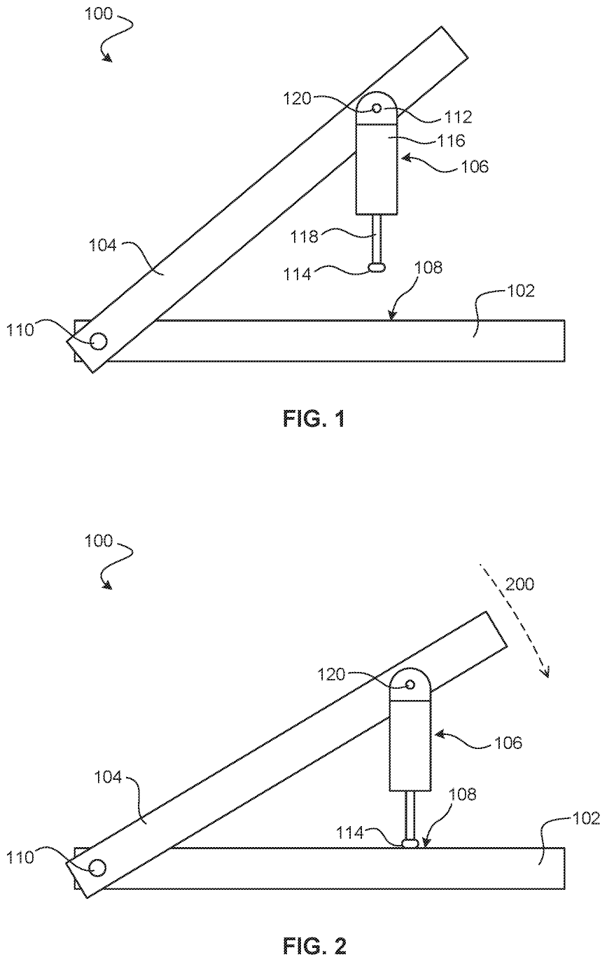

FIG. 1 shows an example apparatus 100. The apparatus 100 includes a first component 102, a second component 104, and a damper 106. The terms “first,” “second,” etc., as used herein are to distinguish among components and carry no other connotation.

The first component 102 may be a member fixed within a frame of reference. The first component 102 may be a base portion of an electromechanical apparatus, such as a scanner, copier, printer, multi-function device, or similar.

The first component 102 includes an abutment 108, which may include a surface, raised feature, indentation, recess, or other feature to receive contact of a free end of the damper 106 and provide a reactive force to the damper 106.

The second component 104 is rotatable with respect to the first component 102, which may include the second component 104 being connected to the first component 102 by a hinge 110, pivot point, or similar joint. The second component 104 may be rotatably connected to a component other than the first component 102. The second component 104 may be a lid portion of an electromechanical apparatus, such as a scanner, copier, printer, multi-function device, or similar.

In other examples, the second component 104 may be fixed with respect to a frame of reference and the first component 102 may be rotatable within the frame of reference. In still other examples, both the first and second components 102, 104 may be rotatable within a frame of reference. In addition, rotation does not exclude other modes of movement. For example, the second component 104 may rotate and while translating.

The damper 106 includes a pivot end 112 that is pivot connected to the second component 104 and a free end 114 that is unconstrained and free to abut the abutment 108 at the first component 102. As depicted, the pivot end 112 may be an end at a cylinder 116 of the damper 106, such as an oil-filled cylinder or the like. The free end 114 may be an end at a translatable member 118 that extends from a piston disposed within the cylinder 116. The orientation of the damper 106 illustrated may be reversed. That is, the free end 114 may be at the cylinder 116 and the pivot end 112 may be at the translatable member 118. A pivot connection 120 may be provided between the pivot end 112 of the damper 106 and the second component 104. The pivot connection 120 is to allow rotational motion of the damper 106 with respect to the second component 104 and may include a pin or rod engaged with a sleeve or bushing, or similar structure

At various positions of the second component 104 with respect to the first component 102, the free end 114 may be distant from the abutment 108, as shown in FIG. 1.

The damper 106 is to dampen movement of the second component 104 when the free end 114 abuts the abutment 108 at the first component 102. That is, as the second component 104 is rotated towards the first component 102, the free end 114 of the damper 106 comes into contact with and abuts the first component 102 and dampens continued movement of the second component 104.

FIG. 2 shows the second component 104 rotated with respect to the first component 102, as compared to FIG. 1, in a clockwise direction 200 about the hinge 110. The terms “clockwise” and “counterclockwise,” as used herein, are for sake of explanation only and are not intended to be limiting. In the position depicted, the free end 114 of the damper 106 is just in contact with the abutment 108 at the first component 102 and dampening does not yet occur.

The second component 104 may include a free range of motion with respect to the first component 102. In the free range of motion, the free end 114 of the damper 106 does not abut the abutment 108 of the first component 102 and dampening may not occur. The free range of motion may span the positions shown in FIGS. 1 and 2.

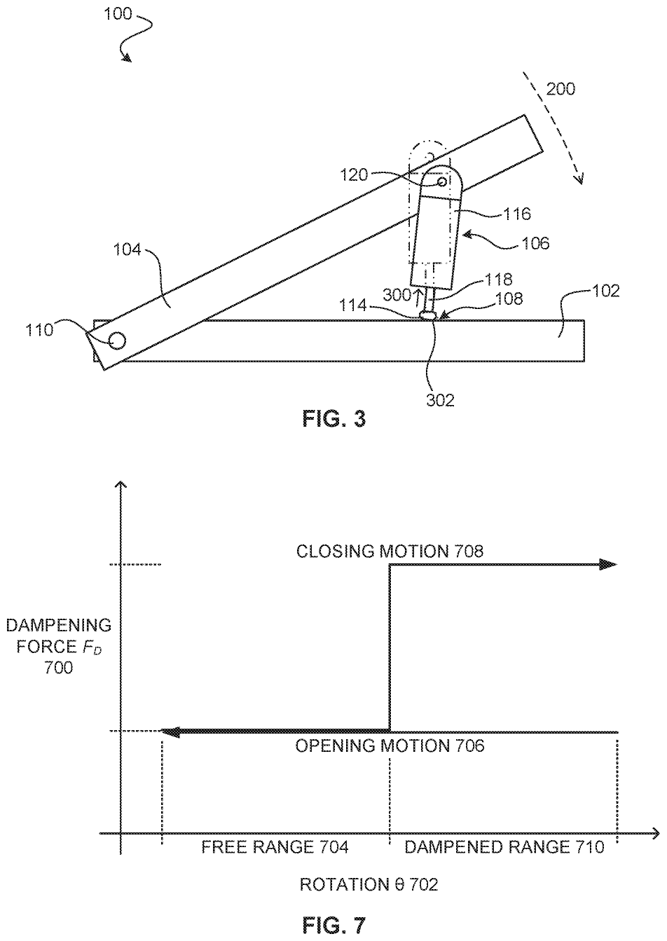

FIG. 3 shows continued rotation of the second component 104 with respect to the first component 102, as compared to FIG. 2, in the clockwise direction 200 about the hinge 110. The free end 114 of the damper 106 abuts the abutment 108 at the first component 102 and dampening occurs by way of, for example, a damper piston sliding within the cylinder 116, as indicated by direction 300.

The second component 104 may include a dampened range of motion with respect to the first component 102. In the dampened range of motion, the free end 114 of the damper 106 abuts the abutment 108 of the first component 102 to effect dampening. The dampened range of motion may span the positions shown in FIGS. 2 and 3. In the dampened range of motion, the damper 106 may rotate about the pivot connection 120 and the free end 114 of the damper 106 may pivot about a point of abutment 302 between the free end 114 and the abutment 108. As the free end 114 is not permanently connected to the abutment 108, the dampened range of motion may be dampened in one sense of motion (clockwise in this view), and may be undampened in an opposite sense of motion (counterclockwise in this view).

The damper 106 may be a linear damper having a translatable piston within a fluid-containing cylinder. The damper 106 may be biased to urge the free end 114 to abut with the abutment 108 of the first component 102. A return bias may be provided to the damper 106 to urge the translatable member 118 to move in an extending direction opposite the contracting direction 300. A return bias element, such as a spring, may be located inside or outside the damper. The return bias may cause the free end 114 to extend towards the first component 102 when, for example, the second component 104 is rotated with respect to the first component 102 about the hinge 110 in an opening (e.g., counterclockwise) direction opposite the closing direction 200. That is, as the second component is moved from the dampened range of motion to the free range of motion, the return bias of the damper 106 may extend the translatable member 118 in preparation for further dampening when motion is reversed back to the closing direction 200. Further, transition from the dampened range of motion to the free range of motion may be undampened, as the free end 114 of the damper 106 is free to depart from the abutment 108, whether or not such departure is taken up by biased extension of the translatable member 118.

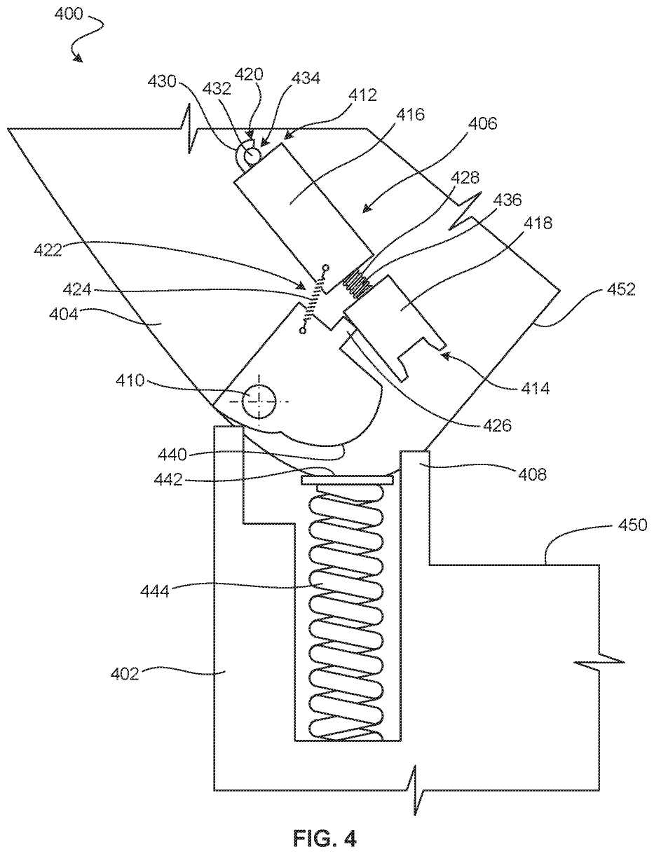

FIG. 4 shows an example electromechanical apparatus 400, such as a scanner, copier, printer, multi-function device, or similar. The apparatus 400 is similar to the other apparatuses described herein and description of the other apparatuses may be referenced. The apparatus 400 includes a base 402, a lid 404, and a damper 406. The lid 404 is rotatable with respect to the base 402 by a hinge 410. The damper 406 is positioned away from the hinge 410.

The base 402 includes an abutment 408, which may include a raised feature, such as the protrusion depicted, to receive contact of a free end of the damper 406 and provide a reactive force to the damper 406.

The damper 406 includes a pivot end 412 that is rotatably attached to the lid 404 and a free end 414 that is free to abut the abutment 408. The damper 406 may be a linear damper. The damper 406 may include a cylinder 416 that contains fluid and a piston disposed within the cylinder 416. A translatable member 418 may extend from the piston to linearly translate with the piston. The free end 414 may be at the member 418. A rotational joint 420 may be provided at the pivot end 412. The orientation illustrated may be reversed, in that the free end 414 may be at the cylinder 416 and the pivot end 412 may be at the translatable member 418.

A return bias may be provided to the damper 406 to urge the translatable member 418 to an extended position shown in FIG. 4. The return bias may include a coil spring 428 that is positioned around a shaft 436 that rigidly connects the translatable member 418 to a piston internal to the cylinder 416. The coil spring 428 may be compressed by opposing surfaces of the translatable member 418 and the cylinder 416 to provide force against the opposing surfaces of the translatable member 418 and the cylinder 416 to urge the translatable member 418 away from the cylinder 416.

The damper 406 is to dampen movement of the lid 404 when the free end 414 abuts the abutment 408 at the base 402. A range of motion in which the free end 414 is distant from the abutment 408 may be termed a free range of motion. A range of motion in which the free end 414 abuts the abutment 408 may be termed a dampened range of motion. As the free end 414 of the damper 406 is free to depart from the abutment 408 without the damper being extended to exert a dampening force, it may be that only one sense or direction of movement of the lid 404 in the dampened range of motion is dampened. An opposite sense or direction of movement may be undampened by the damper 406.

The electromechanical apparatus 400 may further include a damper bias element 422 to bias the damper 406 to a fixed orientation with respect to the lid 404. This may help maintain alignment of the free end 414 of the damper 406 to the abutment 408 at the base 402, so that consistent registration of the free end 414 to the abutment 408 may be achieved. The bias element 422 may include a spring 424 that connects the cylinder 416 of the damper 106 to the lid 404 and urges the damper 106 to rotate into contact with a stop 426 at the lid 404. The translatable member 118 of the damper 106 may be urged against the stop 426 by the spring 424 to maintain orientation of the damper 106.

The damper 406 may be pivotally attached to the lid 404 by a rotational joint 420, which may be detachable to allow the damper 406 to be attached, removed, and/or replaced. The damper 406 may be removably pivot connected to the lid 404. The rotational joint 420 may include a sleeve 430 and a rod 432 to rotatably fit within the sleeve 430. A snap-type connection may be implemented, in which the sleeve 430 snaps onto the rod 432. The sleeve 430 may define a gap 434 to allow passage of the rod 432 into and out of the sleeve 430 to allow the damper 406 to be attached and detached from the lid 404. In the example depicted, the rod 432 is fixed to the lid 404 and the sleeve 430 is fixed to the damper 406. This may be reversed and in other examples the rod 432 may be fixed to the damper 406 and the sleeve 430 may be fixed to the lid 404.

The electromechanical apparatus 400 may further include a cam surface 440 to engage a biased surface 442 to bear a portion of the weight of the lid 404, as the lid is closed. The cam surface 440 may be provided to the lid 404. The biased surface 442 may be biased by a spring 444 that is provided to the base 402.

The electromechanical apparatus 400 may further include components to provide functionality such as scanning, printing, copying, and the like. Such components may include a glass platen 450 at the base 402, a backing surface 452 at the lid 404, a print engine, an optical scanning assembly, a sheet feeder, a finisher, and similar. In the example shown, the lid 404 may be closed against the base 402 to bring the backing surface 452 towards the platen 450 to press a physical medium, such as paper, against the platen 450 for scanning, copying, or similar operation.

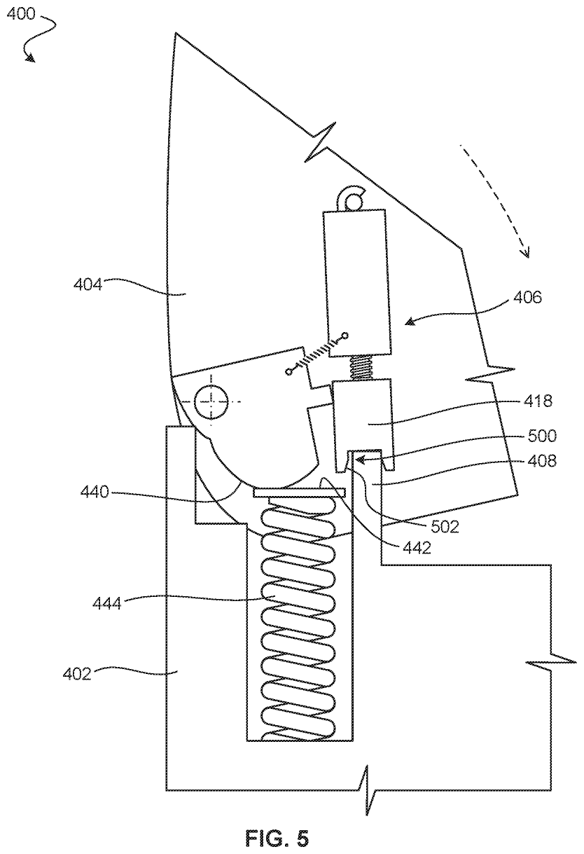

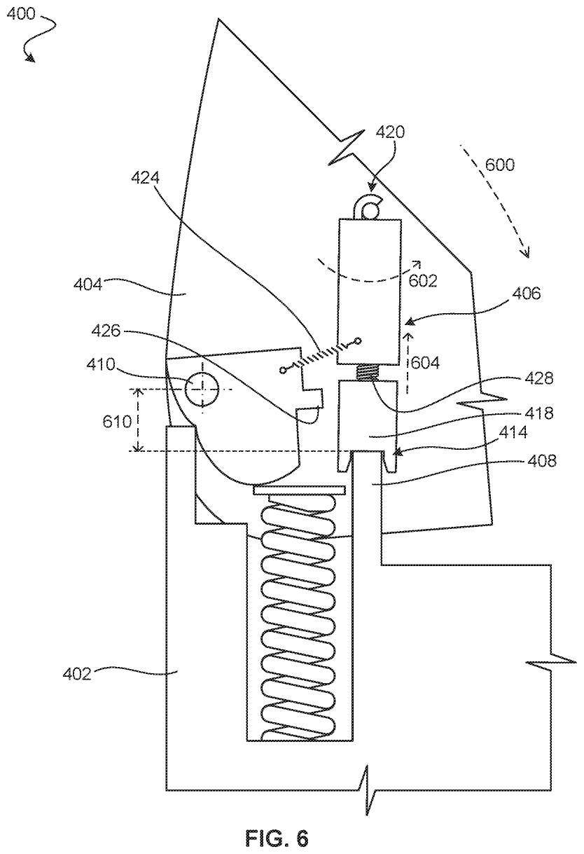

The lid 404 may be rotated with respect to the base 402 through a free range of motion, in which the damper 406 is not active, into to a dampened range of motion, in which the damper 406 is active. A position in the free range of motion is shown in FIG. 4. FIG. 5 shows a transition position between the free range of motion and the dampened range of motion. A position in the dampened range of motion is shown in FIG. 6.

In the free range of motion, the free end 414 of the damper 406 does not abut the abutment 408 to provide a dampening force to a closing motion of the lid 404, In the dampened range of motion, the free end 414 of the damper 406 abuts the abutment 408 to provide a dampening force to a closing motion of the lid 404. As the free end 414 is free to be lifted or otherwise depart from the abutment 408, opening motion of the lid 404 may not cause the damper 406 to provide a dampening force in both the free range of motion and the dampened range of motion, as shown in the plot of FIG. 7.

As shown in FIG. 5, the translating member 418 of the damper 406 may be provided with a recess 500 to accommodate the abutment 408. The recess 500 may include a sloped or curved entry surface 502 to guide the recess 500 into registration with the abutment 408.

As shown in FIGS. 5 and 6, the cam surface 440 may contact the biased surface 442 to compress the spring 444 to balance weight of the lid 404.

Further, as shown in FIG. 6, in the dampened range of motion, when the free end 414 of the damper 406 engages with the abutment 408, continued rotation of the lid 404 with respect to the base 402 in closing sense 600 causes the damper 406 to pivot about the rotational joint 420 in an opposite sense 602 with respect to the lid 404. For example, clockwise motion of the lid 404 causes counterclockwise motion of the damper 406 with respect to the lid 404, Rotation of the damper 406 causes the translatable member 418 to travel away from the stop 426 against the urging of the spring 424. At the same time, the damper's stroke is closed in a direction 604, which may act against a returning force provided by the coil spring 428, as dampening is effected,

The rotational connection 420 may allow a line of action of a force exerted on the damper 106 by the abutment 108, and its reaction force at the rotational connection 420, to align with the stroke of the damper 406, as illustrated by the direction 604, This may reduce wear of the abutment 408 and the damper 406 and may reduce a risk of failure of the damper 406. The pivoting provided by the rotational connection 420 and the free end 414 may serve to reduce lateral loading on a linear damper 406.

A spacing 610 may exist between the abutment 408 and the hinge 410 in a direction approximately parallel to the direction 604 of action of the damper 406 in the dampened range of motion, as shown in FIG. 6. The spacing 610 may be selected to provide a selected amount of rotation of the damper 406 in the sense 602 opposite the sense 600 of rotation of the lid 404,

FIG. 7 shows an illustrative plot of dampening force 700 provided by an example damper having rotatable and free ends as described herein with respect to relative rotation 702 of components to which the damper is provided, such as a base and a rotatable lid. In a free range of motion 704, both an opening motion 706 and a closing motion 708 of the lid or other component cause the damper to provide low or no dampening force. In a dampened range of motion 710, the opening motion 706 cause the damper to provide low or no dampening force, while the closing motion 708 causes the damper to provide a relatively high dampening force.

In view of the above, it should be apparent that the rotatable and free end constraints of the dampers described herein may allow such dampers to be easily installed. Further, wear or potential for damage to a damper or other component of an apparatus having such a damper may be reduced. User satisfaction with an apparatus having such a damper may increase, as a lid or other component may be prevented from slamming or causing damage during closing, while the lid or other component may be easier to move during opening. In addition, location of a damper away from a hinge of an electromechanically apparatus may allow a linear damper to be used efficiently. Moreover, the damper may be provided separately from the hinge and a weight-carrying spring, so that several different dampers may be provided for modular selection for various apparatuses with various different hinges and weight-carrying springs.

It should be recognized that features and aspects of the various examples provided above can be combined into further examples that also fall within the scope of the present disclosure. In addition, the figures are not to scale and may have size and shape exaggerated for illustrative purposes

1. An apparatus comprising:
a first component including an abutment;
a second component rotatable with respect to the first component; and
a damper including a pivot end that is pivot connected to the second component and a free end that is free to abut the abutment of the first component, the damper to dampen movement of the second component when the free end of the damper abuts the abutment of the first component.

2. The apparatus of claim 1, wherein the second component includes a dampened range of motion with respect to the first component, in which the free end of the damper abuts the abutment of the first component.

3. The apparatus of claim 2, wherein the damper is to pivot about the pivot end in the dampened range of motion of the second component.

4. The apparatus of claim 2, wherein the second component includes a free range of motion with respect to the first component, in which the free end of the damper does not abut the abutment of the first component.

5. The apparatus of claim 4, further comprising a damper bias element to bias the damper at a fixed orientation in the free range of motion of the second component.

6. The apparatus of claim 1, wherein the damper is a linear damper that is biased to urge the free end to abut with the abutment of the first component.

7. The apparatus of claim 1, wherein the pivot end of the damper is removably pivot connected to the second component.

8. The apparatus of claim 7, wherein a pivot connection of the pivot end of the damper to the second component includes a sleeve and a rod to rotatably fit within the sleeve, the sleeve defining a gap to allow passage of the rod into and out of the sleeve to allow the damper to be connected and disconnected from the second component.

9. An apparatus comprising:
a base including an abutment;
a lid rotatable with respect to the base; and
a damper attached to the lid by a rotational joint, the damper including a free end that is free to abut the abutment of the base, the damper to dampen movement of lid when the free end of the damper abuts the abutment of the base.

10. The apparatus of claim 9, wherein the damper is detachably attached to the lid.

11. The apparatus of claim 10; wherein the damper comprises a cylinder and a translatable member that is to linearly translate with respect to the cylinder, wherein the cylinder is attached to the lid by a rotational joint and the free end is at the translatable member.

12. The apparatus of claim 11, wherein the translatable member defines a recess to accommodate the abutment.

13. The apparatus of claim 12, wherein the translatable member includes an entry surface to guide the recess into registration with the abutment.

14. An apparatus comprising:
a first component;
a second component rotatable with respect to the first component; and
a damper rotatably connected to the second component, the damper including a free end that is free to contact the first component;
the second component including a free range of motion with respect to the first component in which the free end of the damper is distant from the first component, the second component including a dampened range of motion with respect to the first component, the damper to provide a dampening force by contact of the free end to the first component in response to a closing motion of the second component in the dampened range of motion.

15. The apparatus of claim 14, wherein the damper is to urge the free end to depart from the first component in response to an opening motion of the second component in the dampened range of motion.
